(19) United States
(12) Patent Application Publication
(10) Pub. No.: US 2002/0156575 A1
(43) Pub. Date: Oct. 24, 2002

(54) Method for determining the position of a land vehicle having a navigational system, and device for implementing the method

(76) Inventors: Volker Skwarek, Bad Salzdetfurth (DE); Gerd Draeger, Braunschweig (DE)

Correspondence Address: KENYON & KENYON, ONE BROADWAY, NEW YORK, NY, 10004, US

(21) Appl. No.: 10/061,814

(22) Filed: Feb. 1, 2002

(30) Foreign Application Priority Data
Feb. 9, 2001 (DE) 101 05 901.9

(51) Int. Cl. G01C 21/26

(52) U.S. Cl. 701/213; 455/456; 340/988

(57) ABSTRACT

A method for determining the position of a land vehicle having a navigational system, and a device for implementing the method. A combined evaluation of the data that are receivable from a satellite navigation system and from a terrestrial, cellular mobile telephony network is undertaken. Moreover, the accuracy of the position calculable from the receivable data is estimated, and the position is then calculated on the basis of the data having the highest estimated accuracy.

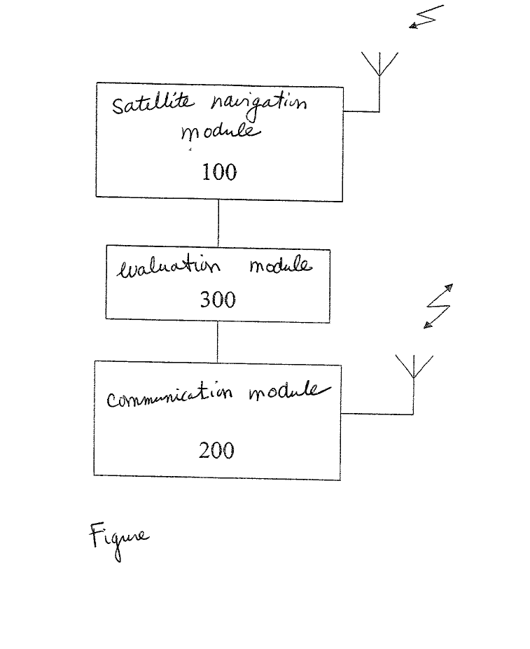

### BACKGROUND OF THE INVENTION

In land vehicles, it is generally known to determine one's position using a satellite navigation system, such as a GPS or GNSS (Global Navigation Satellite System). The position specifications are usually indicated by degrees of latitude and longitude, as well as by the elevation above sea level.

When satellite navigation systems are used for position finding in built-up, urban areas, the quality of the results attained is seriously limited. For example, shadowing can interrupt the satellite connections necessary for position finding, or signal reflection, for example off of house walls, can result in degraded and multipath-encumbered signals.

### SUMMARY OF THE INVENTION

The present invention undertakes a combined evaluation of the data that are receivable from a satellite navigation system and from a terrestrial, cellular mobile telephony network. It is, namely, also possible to undertake a position finding via a mobile radiocommunication network, since such a network includes a plurality of radio base stations, which can, in part, be received simultaneously, and to transmit the distance between the radio base station and a mobile terminal as encoded information on the basis of the field strength and a timing-advance specification. It is directly in built-up, urban areas, where the availability of satellite data is limited, that one finds a high density of radio base stations belonging to the mobile radiocommunication network, so that the two position-finding possibilities may complement one another.

The method according to the present invention combines two different position finding methods in such a way that the availability and/or accuracy of the position finding are altogether enhanced. This is especially effective when working with navigational systems that do not carry along any complete digital road map, but rather a thinned-out map via an air (radio) interface.

A further refinement provides for estimating the accuracy of the position calculable from the receivable data, and for the position to then be calculated on the basis of the data having the highest estimated accuracy. In this manner, depending on the availability of the systems, a greatest possible accuracy is also achieved.

In addition, one may also calculate a position from that data which has the same or a lesser estimated accuracy. The resultant total (composite) position is determined by correlating the two partial positions, a weighting of the accuracy in question being undertaken. By applying these measures, one may then determine a total position, whose accuracy is greater than that of each of the individually ascertained positions.

In a device for implementing the method, provision is made for a satellite navigation module and a communications module, whose outputs are linked to an evaluation module. In this evaluation module, the individual positions are combined in a calculation performed by a computer using Kalman filtering, for example, as the computation method.

One further refinement provides for the evaluation module to be a self-contained module or for it to be integrated in the satellite navigation module and/or the communications module. A self-contained module makes it possible for the satellite navigation module or the communications module to be adapted on an individual basis to technological advances or to modified systems. On the other hand, when the evaluation module is integrated in the one and/or the other module, this means that existing subassemblies or software are utilized, so that cost savings are achieved.

### BRIEF DESCRIPTION OF THE DRAWINGS

The FIGURE shows a block diagram of the device according to the present invention.

### DETAILED DESCRIPTION

The device shown as a block diagram in the FIGURE includes a module 100 for receiving satellite signals, preferably a GPS receiver, as well as a module 200 for receiving terrestrial communications signals, preferably a GSM (Global System for Mobile Communications) module, as well as an evaluation module 300. From systems 100 and 200, the evaluation module receives information for calculating the positional information. This information is combined in a logic operation and evaluated in order to improve the availability and/or accuracy.

In a first scenario, a land vehicle traveling in a congested urban area regularly loses contact with the GPS satellites, so that, at the most, it only has two satellites still available. As a result, an adequate position finding is no longer possible. In this case, the position finding offered by the mobile radiocommunication network is used as an alternative.

In a second scenario, a land vehicle traveling in a rural area does not have adequate mobile radiocommunication coverage since it is a very low-density area. Here, the GPS position finding is used, since it is precisely in low density areas that it functions very well.

In a third scenario, the land vehicle is in an area where both GPS, as well as mobile-radiocommunication position finding are available (function) with reasonable accuracy In this case, one may minimize the position-finding error by using the measured quantities to compensate for parameters in suitable computation procedures.

What is claimed is:

1. A method for determining a position of a land vehicle having a navigational system, the method comprising:
undertaking a combined evaluation of data receivable from a satellite navigation system and from a terrestrial, cellular mobile telephony network.

2. The method according to claim 1, further comprising:
estimating an accuracy of a position calculable from the receivable data; and
calculating the position as a function of data having a highest estimated accuracy.

3. The method according to claim 2, further comprising:
further calculating a position from data that has at most the same estimated accuracy;
determining a composite position by correlating two partial positions; and
undertaking a weighting of the accuracy.

4. A device for determining a position of a vehicle, comprising:
a satellite navigation module;
a mobile communications module; and
an evaluation module for receiving outputs of the satellite navigation module and the mobile communications module, the evaluation module undertaking a combined evaluation of data from the satellite navigation module and the mobile communications module.

5. The device according to claim 4, wherein the evaluation module is a self-contained module.

6. The device according to claim 4, wherein the evaluation module is integrated in at least one of the satellite navigation module and the mobile communications module.
